(19) United States
(12) Patent Application Publication
(10) Pub. No.: US 2008/0278444 A1
(43) Pub. Date: Nov. 13, 2008

(54) USER INPUT SYSTEM

(76) Inventors: Anna C. Schelling, Rochester, NY (US); Wilbert F. Janson, JR., Shortsville, NY (US)

Correspondence Address: David A. Novais;Patent Legal Staff, Eastman Kodak Company, 343 State Street, Rochester, NY, 14650-2201, US

(21) Appl. No.: 11/747,855

(22) Filed: May 11, 2007

(51) Int. Cl. G06F 3/033

(52) U.S. Cl. 345/157

(57) ABSTRACT

User input systems are provided having a core extending along a length and an input sleeve having an exterior surface and an interior surface shaped and sized to receive the core. A slide sensing system has a slide sensor that senses sliding movement of the input sleeve relative to the core and that causes a slide signal to be generated that indicates at least that the input sleeve has been moved along the length of the core and a direction of such movement. A rotation sensing system has a rotation sensor that senses rotational movement of the input sleeve relative to the core and that causes a rotation signal to be generated that indicates at least that the input sleeve has been rotated relative to the core. A processing system determines an output signal based upon the slide signal and rotation signal.

### CROSS REFERENCE TO RELATED APPLICATIONS

Reference is made to commonly assigned, co-pending patent application U.S. Ser. No. (Attorney Docket 91668, entitled USER INPUT DEVICE, filed concurrently herewith in the name of Schelling et al.

### FIELD OF THE INVENTION

The invention relates to the field of user input systems and methods for converting user input actions into electronic signals that can be interpreted by an electronic device and used to influence the operation of such a device.

### BACKGROUND OF THE INVENTION

There are a wide variety of known user interface devices that allow a human to provide some form of input to an electronic system, such as a computer, appliance, or entertainment device. Traditionally, the most common user interface is the keyboard. However, since the advent of computer operating systems and other software that utilize graphical user interfaces, X-Y input systems have become almost as important as the keyboard. The typical X-Y input system positions an indicator, commonly referred to as a cursor, at a first location on a two-dimensional display. A user drives an input of the X-Y input system in any of a variety of directions. The X-Y input system interprets the extent of such driving into an X-axis displacement and a Y-axis displacement and adjusts the position of the indicator from the initial position along the X axis and Y axis in accordance with the determined displacement. This allows a user to move the cursor so as to navigate within a graphical user interface. X-Y input systems can also be used to provide input signals that particular software programs can interpret to achieve other effects including, but not limited to, changing a virtual perspective and/or virtual position in a first person simulation, navigation between a predetermined matrix of positions in a two dimensional or three dimensional distribution of positions such as a menu or a distribution of targets changing the operation or movement of a simulated person or thing such as in a video game and many other applications.

A wide variety of X-Y input systems are known. One example of such an X-Y input system is the ubiquitous computer mouse. This input system provides a relatively small handheld housing having a ball on the underside. The mouse has sensors that follow the movement of the ball and that produce digital pulses as a function of movement of the mouse along an X direction and/or a Y direction on a surface. The mouse sensors produce digital pulses that an associated control device such as a computer interprets as reflecting an extent of movement of the mouse along the X axis and/or Y axis. One more recent example of such a mouse is described in U.S. Pat. No. 5,706,026, entitled “Finger Operated Digital Input Device” filed by Kent et al. on Mar. 13, 1995 and describes a digital input device that has a thimble worn on a finger and operated as a mouse for displacement encoding or as a point for angular encoding using a base unit. The thimble is also described as being attachable to a stylus to form a tracing pen or joystick handle.

Another more recent type of X-Y input device is the contact sensitive surface that senses a position of contact of an object on the contact sensitive surface. A controller correlates the contact position with a position on a display screen and interprets contact with the surface as an indication that the user wishes to do something at that location. In an alternative embodiment, a controller can detect both of an initial contact position and an amount of displacement from the contact position. In this embodiment, the controller displaces a cursor in accordance with the sensed displacement of the contact position. Such contact sensitive surfaces can be adapted to sense a touch of a user or a co-designed stylus. Examples of contact pad systems that use a stylus can be found in U.S. Pat. No. 6,529,189, entitled “Touch Screen Stylus with IR-Coupled Selection Buttons” filed by Colgan et al. on Feb. 8, 2000, U.S. Patent Publication No. 2004/0160431 entitled “Pointer with Non-Scratch Tip” filed by DiMambro et al. on Feb. 6, 2004. U.S. Pat. No. 5,750,939, entitled “Data Processing System Comprising A Graphic Tablet and Stylus For Use In Such a System” filed by Makinwa et al. on Dec. 6, 1995, and U.S. Pat. No. 5,889,512 entitled “Extendible Stylus” filed by Moller et al. on Jul. 24, 1995. A similar stylus type system is shown for use with a projection monitoring system in U.S. Pat. No. 4,808,980 entitled “Electronic Light Pointer for Projection Monitor” filed by Drumm on Oct. 22, 1987.

Stand alone pen type devices are becoming increasingly common as alternative ways to input data into a computing system. For example, the FLY pentop computer has been introduced as a consumer electronics device that gives users real-time audio feedback as they write and draw on special FLY paper. A user of the FLY platform is able to write on a piece of paper and then interact with the writing directly on the paper. For instance, a FLY pentop computer user can draw a calculator, touch the drawn digits, and function with the pen to perform an operation—then hear the answer announced from the FLY platform. A user also can write a word in one language and hear it translated into another language, or draw a piano keyboard and play it. Systems of this type are described, for example, in U.S. Patent Publication No. 2005/0159206 entitled “Method for Performing Games” filed by Bjorklund et al. on Mar. 11, 1995, in U.S. Pat. No. 5,548,092 entitled “Apparatus and Method of Imaging Written Information” filed by Shirver on Nov. 14, 1994, and U.S. Pat. No. 6,151,015 entitled “Pen Like Computer Pointing Device” filed by Badyal et al. on Apr. 27, 1998.

It will be appreciated that one limitation of the mouse type, contact sensitive systems, and stylus type systems is that they require that a user be capable of displacing the mouse, finger, stylus or pen across a two-dimensional surface having sufficient area for the user to make appropriate control inputs. Such a surface area is not always available to the user such as where the user is attempting to make inputs while moving or such as where the user inputs are to be used by a small, portable, or handheld device, which may not be able to provide sufficient onboard area for the user input to be made.

Trackball systems represent one effort to allow an X-Y input to be entered without requiring movement of an input system across a surface area. Such trackball systems operate using the same principles upon which the mouse operates however, in a trackball system, the user directly engages the ball and adjusts the position of the ball manually. Sensors in the trackball system produce digital pulses that an associated control device such as a computer recognizes as reflecting an extent of rotation of the ball about an X axis and/or a Y axis. Typically, such trackball systems are adapted so that a computer or other control device receiving signals from the trackball system will interpret such signals in a manner that is consistent with signals from a mouse.

Trackball systems require balls that are sized in a manner that is appropriate for manual input which makes such balls larger than the size of the typical mouse ball. Accordingly, trackball balls typically occupy a relatively large amount of space on a surface of an electronic device and, as they are round, they necessarily require that any device incorporating such a trackball have a certain amount of thickness. Further, such trackball systems often require that the user modify the position of the ball with some degree of precision which can be difficult to accomplish while the user is moving.

A further limitation of these systems, described above, is that each of these typically provides only a fixed relationship between an extent of movement of the mouse, pen, stylus, trackball, or finger and an extent of movement of the indicator. However, it will be appreciated that such a fixed relationship is typically a balance between the need to be able to quickly traverse the available display screen and a countervailing need to provide highly accurate placements of the mouse. What is needed therefore is an X-Y type user input system that enables more precise control over placement of the cursor, when required, without requiring repeated actuation of the input system to effect coarse adjustments of the cursor position.

Of course, a wide variety of jog dials and other controllers are known that permit a user to twist or turn a control to achieve some form of scrolling. Recently, the Sony NW-E503 (NWE503), NW-E505 (NWE505), and NW-E507 (NWE507) Network Walkman MP3 player devices provide a rotatable control that can be positioned at any of three positions along the axis of rotation of the control. This is schematically illustrated in FIGS. 1A and 1B which depict a shuttle control switch 12 that is located on an upper end 14 of a body 16 of an MP3 player 10. As is shown in FIG. 1A, shuttle control switch 12 is rotatable about an axis 20 to enable a user to scroll through menu screens presented on a display 18. Shuttle control switch 12 can also slide along the axis 20 into one of three positions. This arrangement provides a single axis input with track settings. To achieve this limited aim, the MP3 player must be specially designed with structures in the central section of the MP3 player body to interact with the shuttle control switch 12 to allow the rotation and sliding mechanical action. Because the body of the controlled device is adapted to physically integrate movement/position sensing electronics within the body of the MP3 player impacting both the appearance and size of the device, and requiring that a user who wishes to access such a control must do so by actually accessing the MP3 player itself

Thus, what is still needed in the art is a two-dimensional user input that can be used by an X-Y input system, or other input system, that is easy to use, that does not require two-dimensional planar input surfaces, that can be readily actuated by a user of a mobile device or other small device and that optionally allows a user to make user inputs with an input that is remote from the device.

### SUMMARY OF THE INVENTION

User input systems are provided having a core extending along a length and an input sleeve having an exterior surface and an interior surface shaped and sized to receive the core. A slide sensing system has a slide sensor that senses sliding movement of the input sleeve relative to the core and that causes a slide signal to be generated that indicates at least that the input sleeve has been moved along the length of the core and a direction of such movement. A rotation sensing system has a rotation sensor that senses rotational movement of the input sleeve relative to the core and that causes a rotation signal to be generated that indicates at least that the input sleeve has been rotated relative to the core. A processing system determines an output signal based upon the slide signal and rotation signal.

### BRIEF DESCRIPTION OF THE DRAWINGS

FIGS. 1A and 1B show an elevation view of a prior art device;

FIG. 2 shows a first embodiment of a user input system;

FIG. 3 shows a cross-section view of the embodiment of FIG. 1;

FIG. 4 shows a second cross-section view of the embodiment of FIG.1;

FIG. 5 shows a schematic view of the user input system of FIG. 1 and a controlled device;

FIGS. 6A-6D show user input system of FIGS. 2-5 useable to control more than one controlled device;

FIGS. 7A and 7B shows an input sleeve 40 that is elastically resilient in a portion of input sleeve;

FIG. 8 shows a user input system of FIGS. 2-5 adapted so as to provide a limited range of rotational motion relative to a core;

FIGS. 9A-9C show perspective views of a user input system on a rigid type of core;

FIGS. 10A and 10B show perspective views of one embodiment of a user input system on a core that is incorporated into a controlled device;

FIGS. 11A, 11B and 11C illustrate yet another embodiment of a user input system having a clip on structure;

FIG. 12 illustrates a user input system on the core of FIGS. 9A-9C being used to send output signals to a controlled device; and

FIGS. 13 and 14 illustrate another embodiment of a user input system with various structures located on an input sleeve thereof.

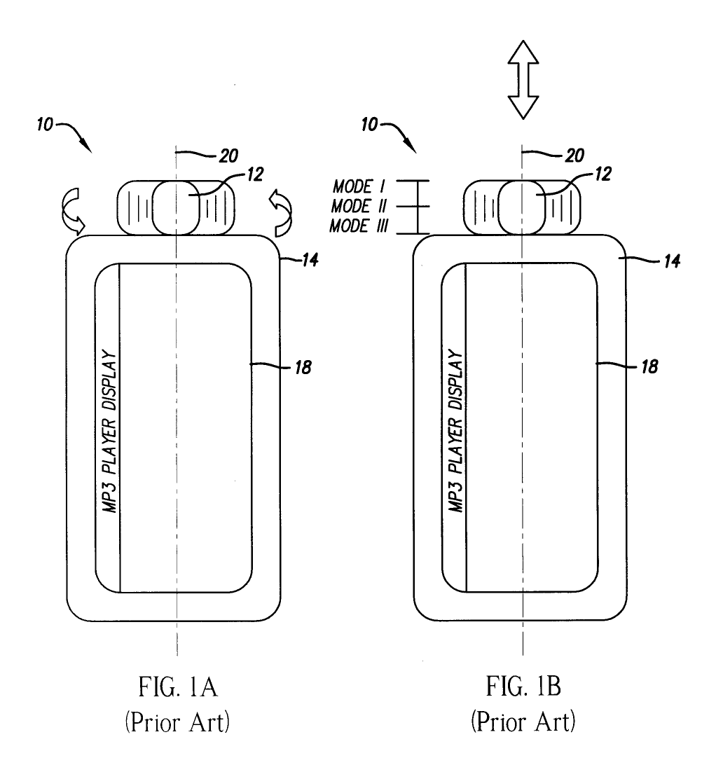

### DETAILED DESCRIPTION OF THE INVENTION

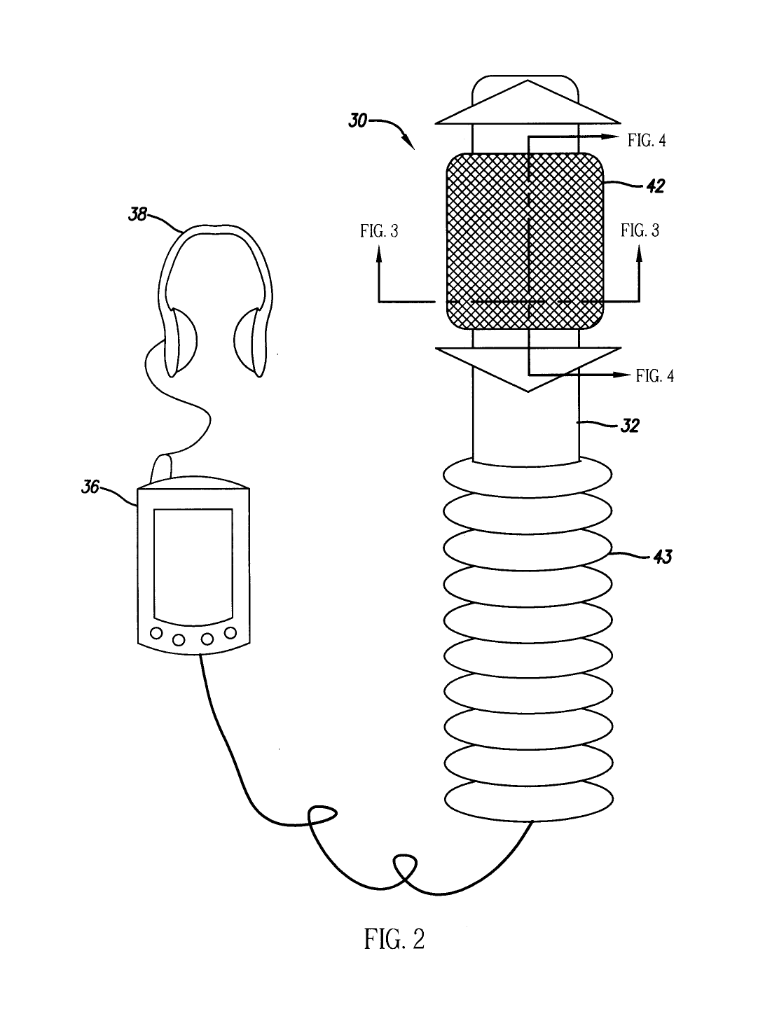

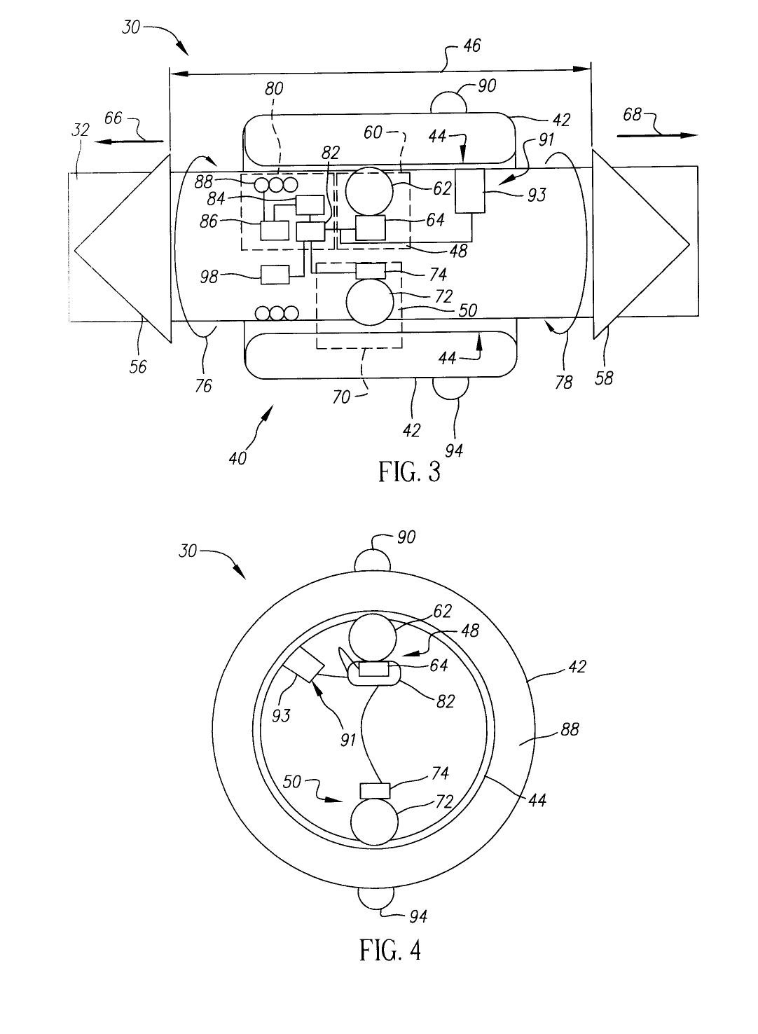

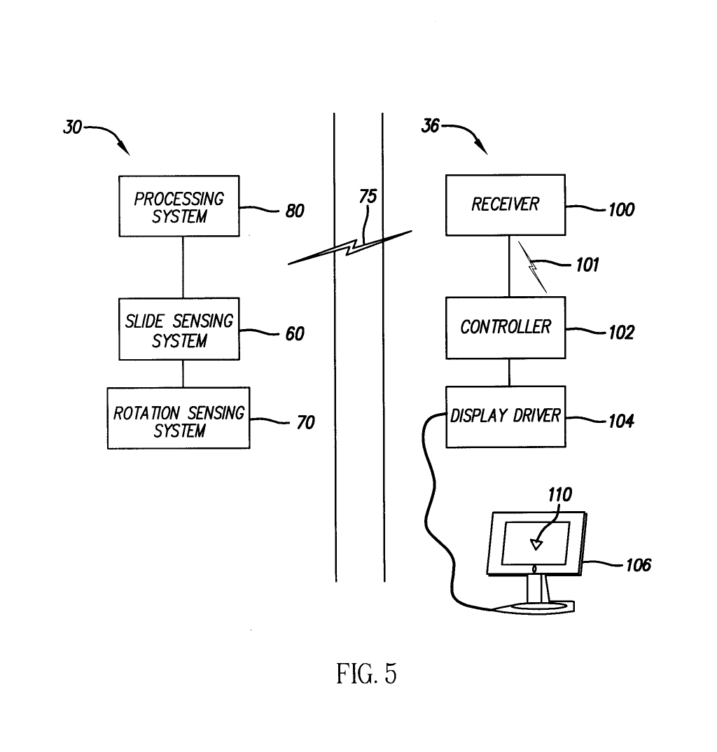

FIG. 2 shows one embodiment of a user input system 30. In the embodiment shown in FIG. 2, user input system 30 is illustrated as being joined to a core 32 that is in the form of a cable leading from a controlled device 36 to a set of headphones 38. In the example of FIG. 2, controlled device 36 is illustrated in the form of a personal digital assistant. However, it will be appreciated that controlled device 36 can take any of a variety of other forms including, but not limited to, a television, an internet appliance, a cellular phone, a digital still camera, a digital video camera, a personal computer, a music player such as an Applie I-Pod™ music player sold by Apple Computer, Cuppertino, Calif., USA, or an MP3 player—another digital music player, a digital still image viewer, a DVD player, a digital motion image viewer such as an MP4 player, or any other digital or analog device requiring two-dimensional user input. FIGS. 3 and 4 show the embodiment of FIG. 2 in cross-section views taken as illustrated in FIG. 2. FIG. 5 shows a schematic view illustrating functional relationships between user input 30 and controlled device 36.

In the embodiment of FIGS. 2-5, input sleeve 40 has an exterior surface 42 and an interior surface 44. Exterior surface 42 is illustrated as being generally round, however in other embodiments, exterior surface 42 can take other shapes including shapes that conform exterior surface 42 to the shape of fingers, thumb and/or palm of a hand of a user that will engage exterior surface 42. Further, it will be observed that, in this embodiment, exterior surface 42 has a surface treatment in the form of a diamond shaped arrangement of grooves to facilitate gripping of exterior surface 42. Other arrangements of exterior surface 42 can be used to facilitate the gripping of the same, including, but not limited to, any arrangement of gel type surfaces or other conforming surface treatments or surface materials that are capable of some degree of deformation in response to the application of a gripping force to exterior surface 42. An optional palm gripping area 43 is also shown that is ribbed to enable better gripping and control of user input system 30.

Interior surface 44 is shaped and sized to receive core 32 in a manner that permits axial movement of input sleeve 40 along a length 46 of core 32 and that also permits rotation of input sleeve 40 around core 32. In the embodiment illustrated, interior surface 44 is shaped in a generally cylindrical fashion with a generally circular cross-section that corresponds generally with the circular cross-sectional shape of core 32 and that is sized slightly larger than core 32. In other embodiments, interior surface 44 can have other shapes consistent with the need for input sleeve 40 to rotate and slide relative to core 32. For example, in other embodiments, interior surface 44 can have a triangular cross section, a rectangular cross section, or other polygonal cross-section. In still other embodiments, interior surface 44 can have a cross-section that takes the form of an arrangement of non-circular curved surfaces. In yet other embodiments, interior surface 44 can have a cross-sectional arrangement that defines one or more guides (not shown) to facilitate movement of input sleeve 40 relative to core 32 which can take the form of, for example, inwardly directed projections on interior surface 44 or can include or incorporate bearing surfaces for ball bearings, wheels and/or other objects arranged to facilitate the sliding movement and/or rotation of input sleeve 40 along and around core 32.

The extent of movement of input sleeve 40 relative to core 32 can be unrestrained or restrained as desired. In the embodiment of FIGS. 2-5 user input system 30 can freely rotate in either direction relative to core 32, however, the extent of sliding movement of input sleeve 40 relative to core 32 is restrained by bumpers 56 and 58 which are joined to core 32 and which limit the length 46 along which input sleeve 40 can slidably move relative to core 32. Core 32 can be rigid or flexible as desired.

As is also shown in the embodiments of FIGS. 2-5, a slide sensing system 60 is provided having has a slide sensor 62 that is adapted to sense axial movement of the input sleeve along a length of the core. As is illustrated in FIGS. 2-5 slide sensing system 60 can be disposed within an area 48 within core 32 such that slide sensor 62 is positioned position proximate to interior surface 44 to sense sliding movement of input sleeve 40 relative to core 32 and a slide encoder 64 that causes a slide signal to be provided that indicates at least that input sleeve 40 has been axially moved along length 46 of core 32 and a direction of such movement along core 32 either in a first direction 66 or a second direction 68. In this embodiment, slide sensor 62 and slide encoder 64 are illustrated as separate components, with slide sensor 62 being illustrated as a follower wheel that is held against interior surface 44 so that it rotates whenever input sleeve 40 slides along length 46. In this embodiment, slide encoder 64 provides well known electro-mechanical structures that detect rotation of slide sensor 62 and that generate or modulate an electrical signal in a manner that indicates an extent and a direction of movement of input sleeve 40 along length 46.

As is also shown in FIGS. 2-5, a rotation sensing system 70 is provided having a rotation sensor 72 that is adapted to sense rotational movement of the input sleeve relative to the core. As is illustrated, rotation sensing system 70 can be disposed within an area 50 within core 32 such that rotation sensor 72 is positioned proximate to interior surface 44 to sense rotation of input sleeve 40 relative to core 32. In this embodiment, rotation sensing system 70 has a rotation sensor 72 that senses rotational movement of input sleeve 40 relative to core 32 and a rotation encoder 74 that causes a rotation signal to be generated that indicates at least an extent to which input sleeve 40 has been rotated relative to core 32 and, optionally, a direction of such rotation such as counter-clockwise direction 76 and clockwise direction 78. In the embodiment illustrated, rotation sensor 72 and rotation encoder 74 are illustrated as separate components, with the rotation sensor 72 being illustrated as a follower wheel that is held against interior surface 44 of input sleeve 40 and that rotates whenever input sleeve 40 rotates relative to core 32. In this embodiment, rotation encoder 74 provides electrical circuits that detect rotation of rotation sensor 72 and that generate or modulate an electrical signal in a manner that indicates an extent and a direction of rotation of input sleeve 40.

A wide variety of other sensors are known that can be used to perform either or both of the sensing of the sliding or rotational movement of input sleeve 40 and the encoding. For example, slide sensor 62 and/or rotation sensor 72 can comprise an optical sensor of a conventional type having a light source (not shown) to direct light onto interior surface 44 and a light sensor (not shown) to detect changes in an amount of reflected light that might be indicative of movement of input sleeve 40 relative to core 32. In this example, interior surface 44 can have grid lines, alternating light and dark patches, alternating patterns of gloss and matte finish, polarizing finish patterns or other characteristics, such as braiding patterns, that might enable such a light sensor to reliably determine an amount and a direction of movement or rotation of input sleeve 40 relative to core 32 based upon an amount of, color of, polarization of or other characteristics of the light that returns to the light sensor (not shown). In another example, interior surface 44 can incorporate embedded grid lines that create detectable variations in a magnetic field near interior surface 44 and slide sensor 62 and/or rotation sensor 72, such as may be caused by metallic or other magnetic materials arranged on or in interior surface 44. In still another embodiment, interior surface 44 can have surface conditions, textured compositional variations or other characteristics that are patterned or otherwise distributed on interior surface 44 such that a tactile proximity, electrical or other type of slide sensor 62 can sense sliding or rotation of input sleeve 40 relative to core 32.

In a further example, slide sensor 62 and rotation sensor 72 can be combined to monitor movement of an intermediary structure such as a single roller ball that extends between core 32 and interior surface 44, and that moves in concert with movement of input sleeve 40 relative to core 32. The movement of such an intermediary can then be monitored by slide encoder 64 and rotation encoder 74.

In the embodiments of FIGS. 2-5, a processing system 80 is illustrated as being within core 32 and as having an input 82 that is connected to slide encoder 64 to receive the slide signal (as illustrated in FIG. 3) and to rotation encoder 74 to receive the rotation signal (as illustrated in FIG. 4). Input 82 is then connected to a processing circuit 84 that is adapted to determine an output signal 75 based upon the slide signal and the rotation signal and from which controlled device 36 can determine what user input actions have been taken using input sleeve 40. Alternatively, processing circuit 84 can provide an output signal 75 in a form that can be interpreted by controlled device 36 as an X-Y input. As can be appreciated from FIG. 2, user input system 30 is self-contained in that it is capable of delivering an output signal indicative of sliding and rotational motion of input sleeve 40 relative to core 32 without necessarily being physically located proximate to controlled device 36. To facilitate this, a communication circuit 86 is provided that receives output signal 75 from processing circuit 84 and that provides output signal 75 in a form that can be conveniently transmitted to controlled device 36. Output signal 75 provided by communication circuit 86 can take any useful form and can be for example, and without limitation, digital or analog forms, and can be in any useful form including, but not limited to, optical, electromagnetic, sonic forms.

In the embodiment that is illustrated, communication circuit 86 converts output signal 75 from processing circuit 84 into the form of an electromagnetic communication signal that can be broadcast using antenna 88, which is illustrated as being coiled within input sleeve 40. In other embodiments, such a radio frequency antenna can take other useful forms. Communication circuit 86, can include, but is not limited to, circuits and systems that communicate in ways that that conform to wireless communication standards including, but not limited to, the so-called “Wi-Fi” standards established and described at Institute of Electrical and Electronic Engineers standards 802.1a, 802.11b, 102.11g and 802.11n, the so-called “Bluetooth” wireless standard including Version 1.2, adopted November, 2003 by the Bluetooth Special Interest Group, Bellevue, Wash., U.S.A., or Version 2.0+Enhanced Data Rate (EDR), adopted November, 2004 by the same or any other such wireless communication standard developed by the Institute of Electrical and Electronic Engineers, the Bluetooth SIG or others in this field. Other communication protocols including but not limited to those used in Radio Frequency Identification systems can also be used.

Alternatively, communication circuit 86 can be adapted to communicate using light technologies, including, but not limited to, infrared technology using protocols established by the Infrared Data Association (IrDA). Such protocols include, but are not limited to the Serial Infrared Protocol (SIR) and other protocols developed by the IrDA.

In still other alternative embodiments, communication circuit 86 can be adapted to communicate using sound signals in the sonic, sub-sonic or ultrasonic ranges. In further embodiments, communication circuit 86 can provide a wired form of communication with controlled device 36 either using an arrangement of conductors or wires that is connected to core 32 or using a separately provided arrangement of wires. In still another embodiment, communication circuit 86 can include an antenna 88 that is adapted to act as an inductor to induce a signal in wires (not shown) in core 32 or separate therefrom.

As is shown in FIG. 5, output signal 75 is received by a receiver 100 at controlled device 36 and converted into a control signal 101 that can be interpreted by controller 102 as indicating an extent and direction of an X axis input and an extent and, optionally, a direction of a Y axis input. Controller 102 is programmed or configured to cause a display driver 104 to adjust a position of a cursor 110 or other positional indicator within a controlled device 106 or otherwise takes action in accordance with the control signal 101 or the determined X-axis and Y-axis input to otherwise put such influence on the operation of the electronic device. It will be appreciated that receiver 100 can be integrated into controlled device 36 or can be separately provided as an add on component to controlled device 36.

As is also shown in the embodiments of FIGS. 2-5, user input system 30 has an optional first switch 90 that can be selectively actuated by a finger or thumb used to grip the exterior surface 42 of input sleeve 40, for example, during slidable movement of input sleeve 40 or during rotation of input sleeve 40. When activated, first switch 90 generates a first switch signal and provides this first switch signal to processing system 80 at input 82. The first switch signal can take any of a variety of well-known forms, such as electro-magnetic, optic or other forms. The first switch signal can be conveyed to input 82 by way of, for example, a wired, wireless or optical connection. In one embodiment, first switch 90 can send a wireless signal that can be sensed by communication circuit 86 and provided to input 82 or processing circuit 84. When input 82 receives the first switch signal input 82 provides the first switch signal or a signal based upon the first switch signal to processing circuit 84 which determines output signal 75 based at least in part upon the signal received from input 82. In one embodiment, processing circuit 84 causes output signal 75 to be transmitted only when the first switch signal is received. This can be done so that inadvertent jostling of input sleeve 40 does not cause signals to be sent to controlled device 36 that might cause an unintended reaction.

In other embodiments, when processing circuit 84 receives a first switch signal, processing circuit 84 determines an output signal 75 that includes a data bit or other selection signal that can be used by controller 102 of controlled device 36 for purposes including, but not limited to, determining that a user wishes to indicate a selection decision at a current location of a cursor.

As is also illustrated in FIGS. 2-5, user input system 30 can further comprise a second switch 94 that can be selectively actuated by fingers, a thumb or palm used to grip exterior surface 42 of input sleeve 40 during slidable movement of input sleeve 40 or during rotation of input sleeve 40. When activated, second switch 94 provides a second switch signal to processing system 80 at input 82. The first switch signal can take any of a variety of well-known forms, such as electromagnetic, optic or other forms. The first switch signal can be converged to input 82 by way of, for example, a wired, wireless or optical connection. In one embodiment, first switch 90 can send a wireless signal that can be sensed by communication circuit 86 and provided to input 82 or processing circuit 84 when input 82 receives the second switch signal, processing circuit 84 determines output signal 75 to be transmitted by communication circuit 86 based at least in part upon the second switch signal.

In still other embodiments, processing circuit 84 can be adapted to determine output signal 75 differently in response to a received slide signal based upon whether a first switch signal is received during receipt of the slide signal or based upon whether a second switch signal is received during receipt of the slide signal. Such a differently determined output signal 75 can, for example comprise an output signal 75 that represents the slide signal in an upwardly or downwardly scaled response to the slide signal. Similarly, processing circuit 84 can be adapted to determine output signal 75 differently in response to a received rotation signal based upon whether a first switch signal is received during receipt of the rotation signal or based upon whether a second switch signal is received during receipt of the rotation signal.

It will be appreciated that the relative orientation of first switch 90 and second switch 94, shown in FIGS. 2-5, is one wherein the first switch 90 positioned on exterior surface 42 in opposition to a position of second switch 94 so that first switch 90 is engageable by one of a thumb or index finger of a user gripping input sleeve 40 using a pincer grip and while second switch 94 is positioned so that it is engageable by a finger of the user who grips the exterior surface using the pincer grip. In such an embodiment, processing system 80 can receive both of the first switch signal and the second switch signal simultaneously and can adjust output signal 75 in response to the simultaneous receipt of the first switch signal and the second switch signal. For example, in one embodiment, where a pincer grip is used to engage both first switch 90 and second switch 94, it is assumed that the user is attempting to take a fine control action as a pincer grip is a grip that enables a person to engage in fine rotation of an object, and accordingly, where such a grip is detected by the simultaneous presence of the first switch signal and the second switch signal, processing circuit 84 can interpret any detected rotation according to an anticipation that the user is attempting to provide a fine control user input.

As is also shown in the embodiments of FIGS. 2-5, user input system 30 can derive operational electrical power sufficient to support operation of user input system 30 from a fixed power supply such as battery 98 or from a fuel cell or other power storage system. Alternatively, or additionally, power can be supplied from photovoltaic sources can be fitted on exterior surface 42. In still another embodiment, operational power can also be derived from the motion of input sleeve 40 relative to core 32, such as by using the motion of a slide sensor 62 or rotation sensor 72 to supply power for use or storage In still another alternative, electrical power sufficient to support operation of user input system 30 can be derived from the flow of energy within signals supplied within conductors (not shown) that are within the core 32 or from energy harvesting of ambient electrical or magnetic fields.

It will be appreciated that the requirements of the above described communication protocols and/or requirements of controlled device 36 may compel conversion of the slide signal, rotation signal, first switch signal or second switch signal or other signals into data that is of a particular format or type and may dictate a particular rate of transmission. Accordingly, processing circuit 84 can also be adapted with well-known circuits and systems to convert the slide signal and the rotation signal into signals that are appropriate for such protocols. This can involve processing steps including but not limited to converting analog signals into digital data, scaling or sampling digital data and/or organizing the digital data into particular forms, and/or compressing the digital data. For example, in certain embodiments, it may be useful for processing circuit 84 to convert these signals into a form that can be conveyed to controlled device 36 by way of the Universal Serial Bus data communication protocol. Further, in some embodiments, it may be desirable for processing circuit 84 to convert the slide signal and rotation signals into conventional forms of X-axis and Y-signals or selections such as those provided by conventional trackball, mouse or contact pad devices. Alternatively, such conversion can be performed at receiver 100 or by controller 102. Methods and equipment for performing such actions are well understood by those of ordinary skill in the art and are therefore not described in detail herein.

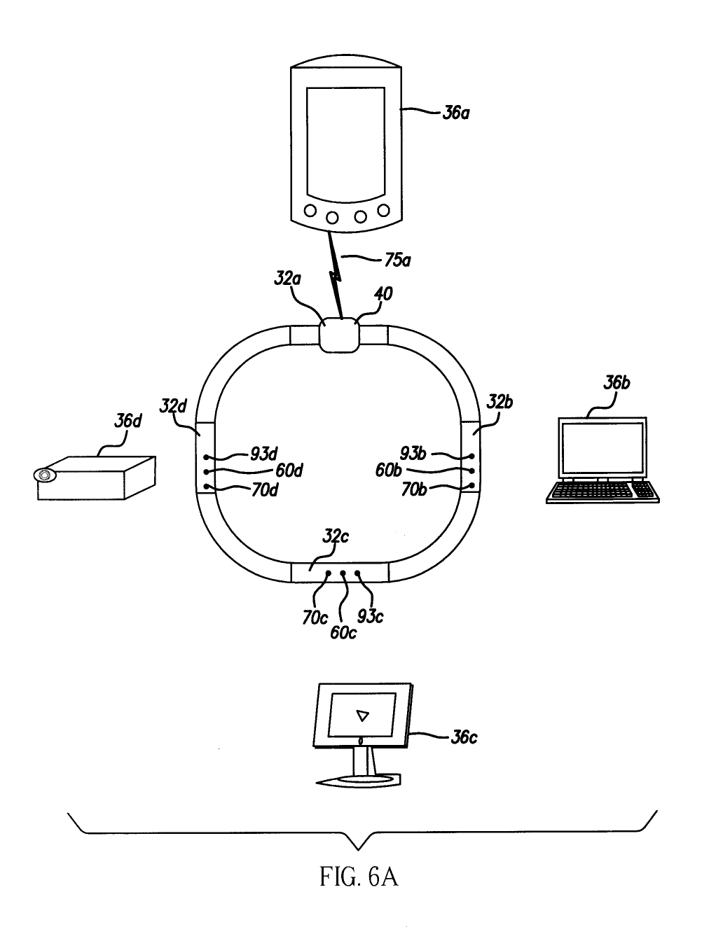

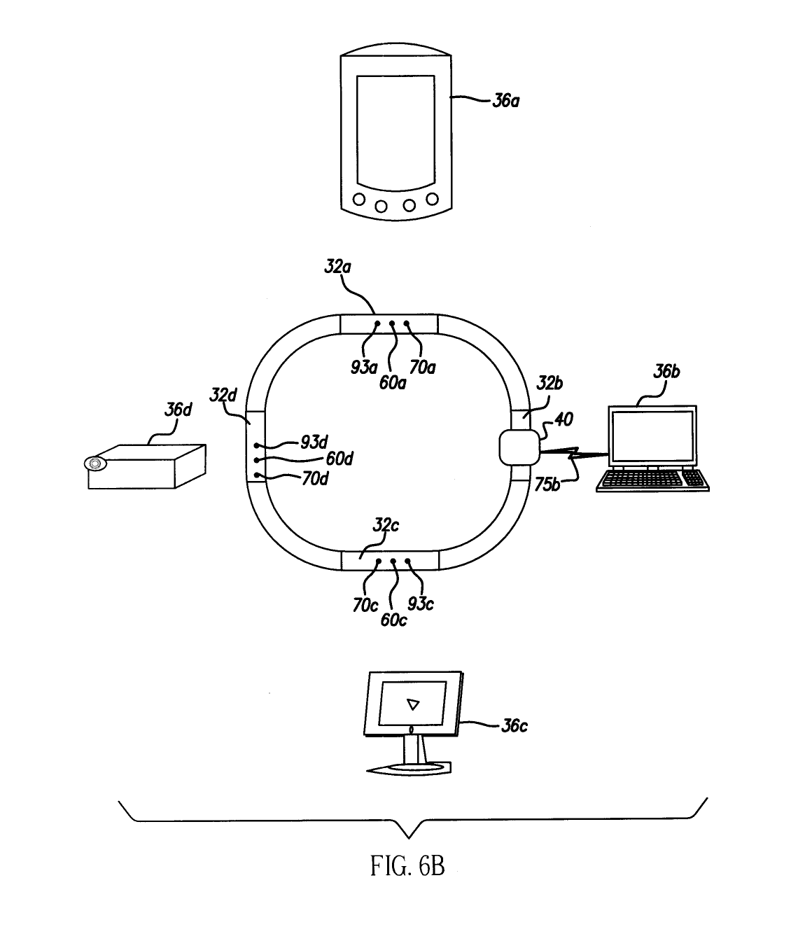

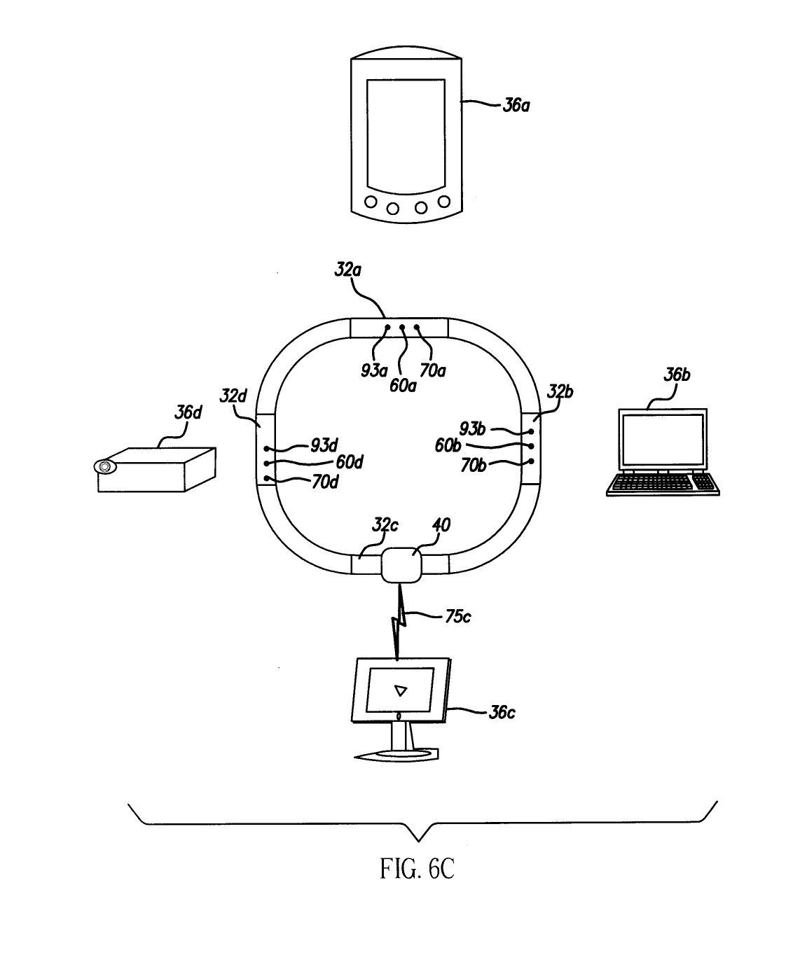

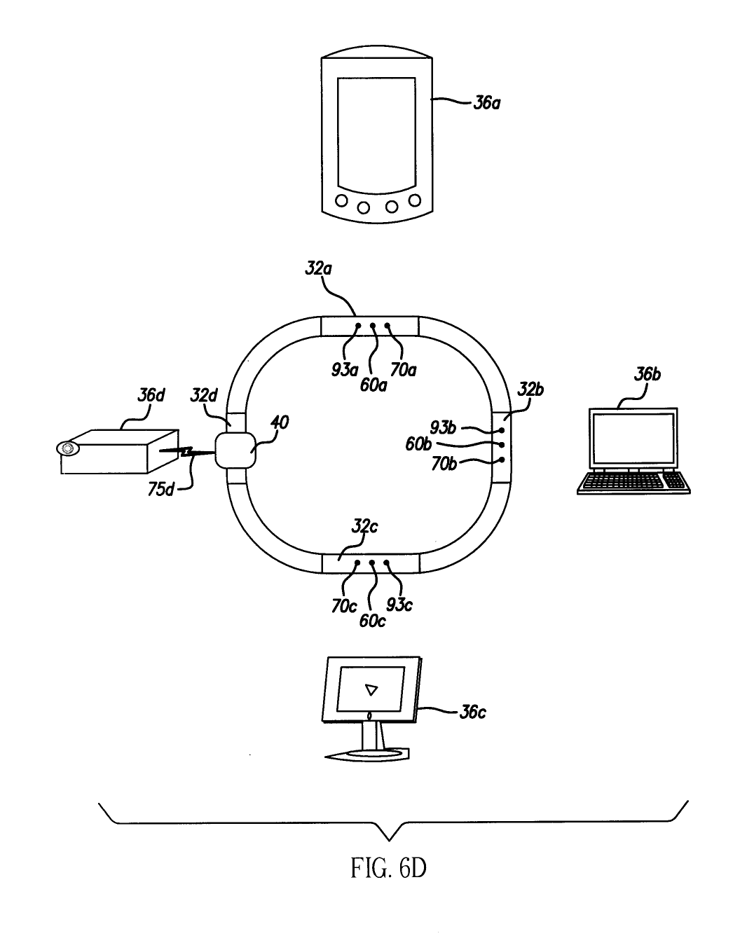

As shown in FIGS. 6A-6D, user input system 30 can be capable of controlling more than one controlled device 36 having, in this embodiment, a core 32 that can be in the form of a ring, cord, luggage component, rope or carabiner type structure having at least two different portions 32a-32d along which input sleeve 40 can be slidably moved and rotated. In this embodiment, user input system 30 can be used to control individual ones of a plurality of controlled devices 36a-36d. As necessary, processing system 80 can provide a processing circuit 84 that is adapted to determine different output signals 75a-75d in accordance with a selection of one of the plurality of controlled devices 36a-36d with each of the different output signals 75a-75d being adapted for use by a particular device. In one embodiment, such an indication of a selection can be made using first switch 90 and/or second switch 94. Other switching arrangements can be provided such as by providing one or more additional switches (not shown) for the purpose of providing an indication of a selection.

In the embodiment of FIGS. 6A-6D, core 32 is sectioned into different portions 36a-36d with each section having a unique slide sensor 60a-60d and/or rotation sensors 70a-70d each generating a distinct slide signal or rotation signal when these sensors are used to determine whether input sleeve 40 has been moved or rotated within a particular one of portion 36a-36d. For example, the slide signal or rotation signal can have different physical, optical, electrical or magnetic characteristics in each portion. In such a case, processing circuit 84 can use differences in such signals to determine which of a plurality of output signals 75a-75d to provide. As is shown in FIG. 6A, when input sleeve 40 is positioned in first core portion 32a, a first type of output signal 75a is generated that is adapted for use by controlled device 36a which is illustrated as a personal digital assistant. Similarly, as is shown in FIG. 6B, when input sleeve 40 is positioned in second core portion 32b a second type of output signal 75b is generated that is adapted for use by controlled device 36b illustrated here as a laptop computer. As is shown in FIG. 6C, when input sleeve 40 is positioned in third core portion 32c a third type of output signal 75c is generated that is adapted for use by controlled device 36c which is illustrated here as a terminal display. Finally, as is illustrated in FIG. 6D, when input sleeve 40 is positioned in fourth core portion 32d a fourth type of output signal 75d is generated that is adapted for use by controlled device 36d which is illustrated here as a projector.

In an alternative embodiment, an optional portion determining system 91 can be provided having a sensor or, as is illustrated here, an array of sensors 93a-93d, such as a mechanical, optical, or electromagnetic switch that can sense a stimulus indicating which portion of core 32 input sleeve 40 is located on and that generates a portion signal that can be provided to input 82 so that processing circuit 84 can generate output signal 75 in a manner that indicates which portion input sleeve 40 is located on. For example, the portions 32a-32d of core 32 can have a sensor 93 such as an optical or hall effect sensor that can be used to sense input sleeve 40. Alternatively, core 32 can have a sensor (not shown) such as an optical, magnetic, electrical or other sensor known in the art that can detect when input sleeve 40 is positioned in different ones of portions 32a-32d.

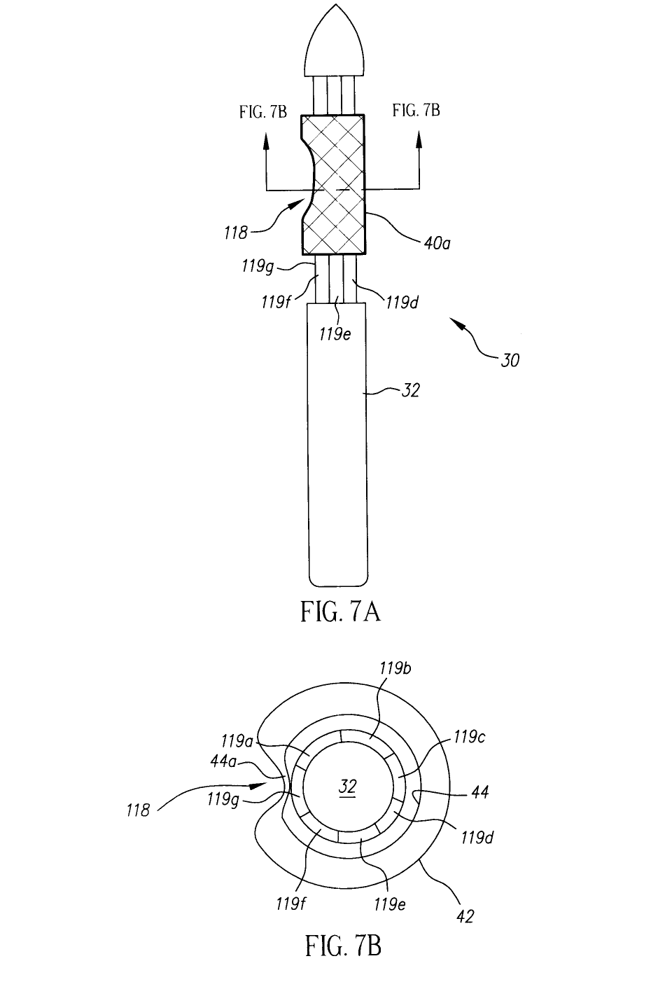

In the embodiment illustrated in FIGS. 7A and 7B, an input sleeve 40 is shown being elastically resilient in a portion 40a of input sleeve 40 such that the application of pressure to exterior surface 42 drives a corresponding portion 44a of interior surface 44 into contact with core 32 such that a contact sensing circuit 118 can detect such contact and generate a first switch signal or second switch signal or both in response thereto. Such contact may be sensed by pressure, conductivity or capacitance sensors of conventional types that are located in or on input sleeve 40. In the embodiment illustrated, a contact sensing circuit 118 is used having segments 119a-119f arranged so a direction of contact can be sensed. This can allow discrimination of first and second switch signals. In this embodiment, interior surface 44 of input sleeve 40 can be metallized, such that when pressure is applied to external surface 42 that drives corresponding portion 44a of interior surface 44 into contact with core 32 a circuit is completed. The completion of this circuit can be interpreted as a first switch signal or a second switch signal. Optionally, in such an arrangement, when pressure is applied to opposing sides of exterior surface 42, such as during the application of a pincer grip to exterior surface 42, electricity will be conducted between two areas of contact with two different segments (e.g. segments 119c and 119g) so that upon compression of exterior surface 42 a circuit is completed between segments 119c and 119g. Input 82 can sense the creation of this circuit can detect this as being indicative of a pincer grip.

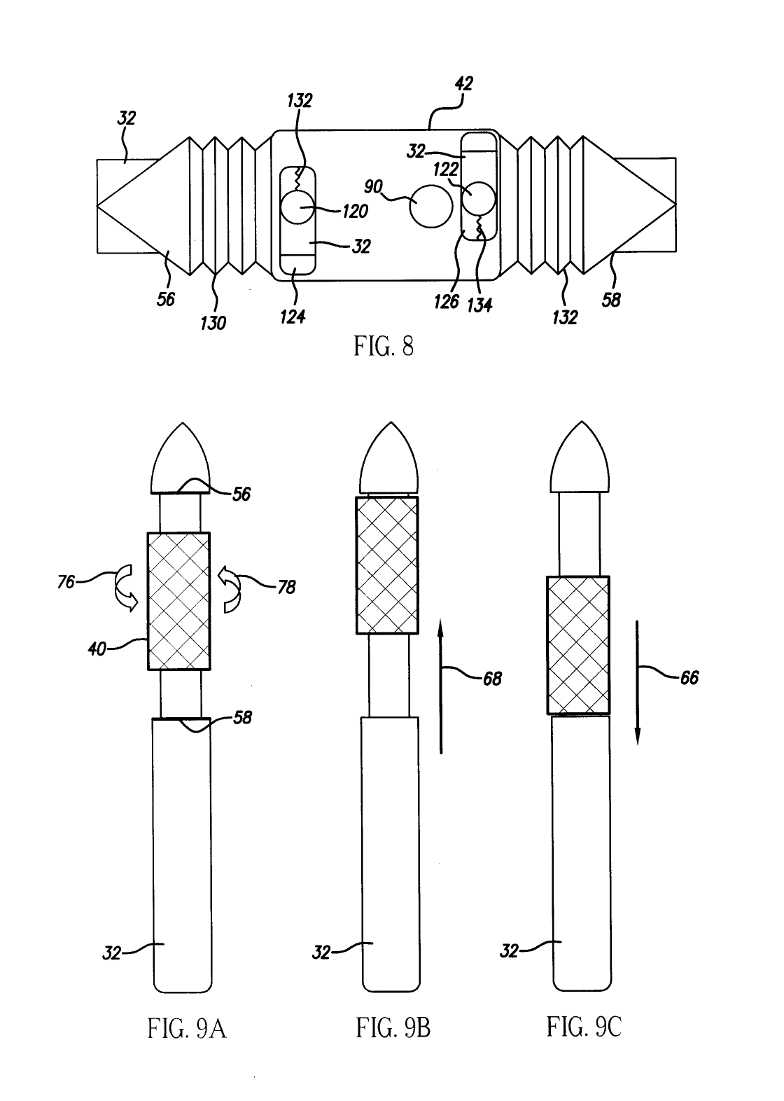

In the embodiment of FIG. 8, user input system 30 of FIGS. 2-5 is optionally adapted so as to provide a limited range of rotational motion relative to core 32 while otherwise working generally as described above. As shown in this embodiment, bumpers 120 and 122 are joined to core 32 within slots 124 and 126 to provide rotational limiters to selectively control an extent of rotation of input sleeve 40 relative to core 32. As is also shown in FIG. 8, in such an embodiment, input sleeve 40 can optionally be biased toward a center position along length 46 by placing resilient members 130 and 132 between bumpers 56 and 58 and input sleeve 40. In the embodiment illustrated, resilient members 130 and 132 take the form of cowels that also offer the ability to resist the entry of contaminants between input sleeve 40 and core 32. As is also illustrated schematically in FIG. 7, input sleeve 40 can be a center biased rotationally by providing resilient members 134 and 136 between bumpers 120 and 122 and slots 124 and 126 respectively. Resilient members 130-136 are illustrated generally in this figure as mechanical springs and can take any of a variety of forms, such as elastically deformable polymers, foams or other such materials or any conventionally known springs. In other embodiments, resilient members 130-136 can also take the form of magnetic pairs with opposing poles of the same type.

In still another embodiment, slide sensor 62 and or slide encoder 64 can be adapted with resilient structures or systems of conventional design that store potential energy as input sleeve 40 is slidably urged away from a center position and that release such potential energy in the form of kinetic energy urging input sleeve 40 back to a center position.

FIGS. 9A-9C show perspective views of another embodiment of user input system 30 and core 32 comprising, in this example, a relatively rigid structure such as a stylus. As shown in FIGS. 9A-9C in this use, input system 30 operates in a fashion that is similar to that described above in FIGS. 2-5, with input sleeve 40 being slidable in two directions 66 and 68 relative to core 32 and being rotatable in two directions 76 and 78, and further generating output signals 75 indicative of such movement.

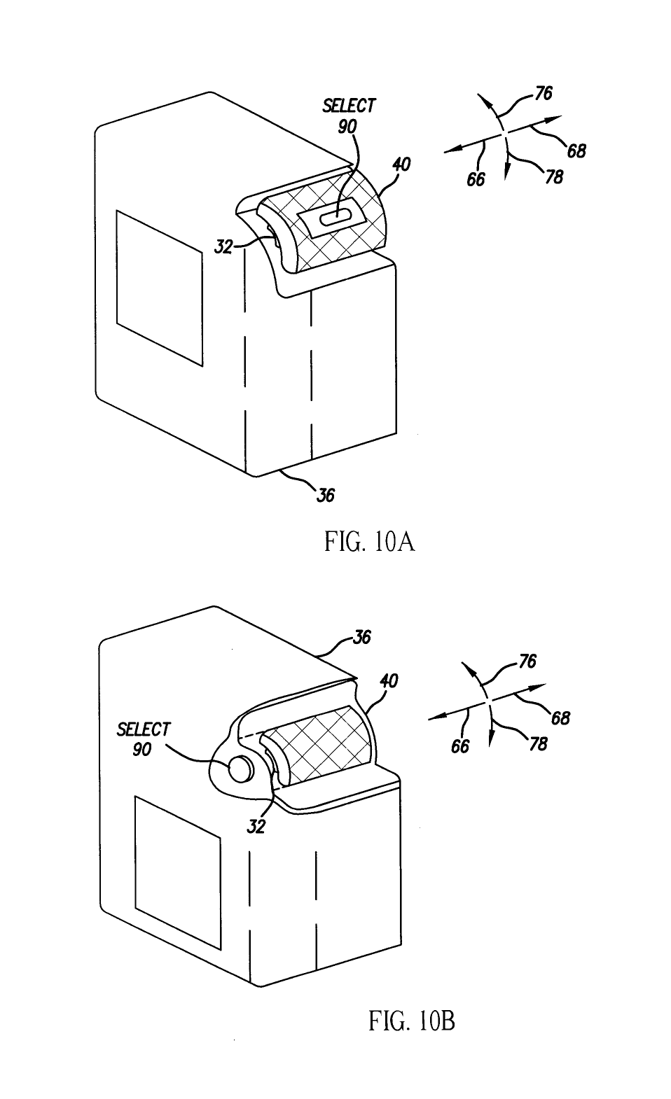

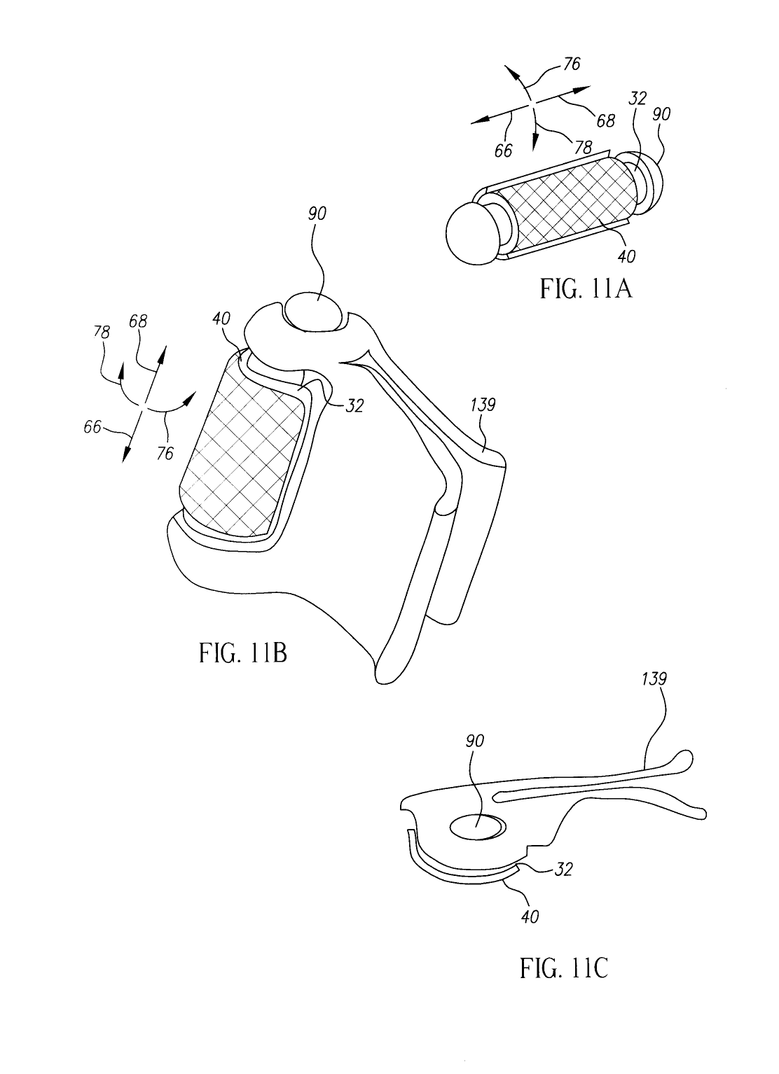

FIGS. 10A and 10B show user input system 30 on a core 32 that is incorporated into a controlled device 36 such as a digital still or digital video camera. As shown in FIGS. 10A and 10B in this use, input system 30 operates in a fashion that is similar to that described above in FIGS. 2-5, with input sleeve 40 being slidable in two directions 66 and 68 relative to core 32 being rotatable in two directions 76 and 78, and further generating output signals 75 as discussed above. Alternative locations for first switch 90 are also shown in these FIGS. 10A and 10B.

FIGS. 11A, 11B and 11C illustrate yet another embodiment of user input system 30 having a clip on feature 139 that can be used to conveniently clip input system 30 to any of a number of items such as articles of clothing and the like. As shown in FIGS. 11A, 11B and 11C, in this use, input system 30 operates in a fashion that is similar to that described above in FIGS. 2-5, with input sleeve 40 being slidable in two directions 66 and 68 relative to core 32 and further being rotatable in two directions 76 and 78, and further generating output signals 75 as discussed above. An optional location for first switch 90 is also shown in these FIGS. 11A, 11B and 11C.

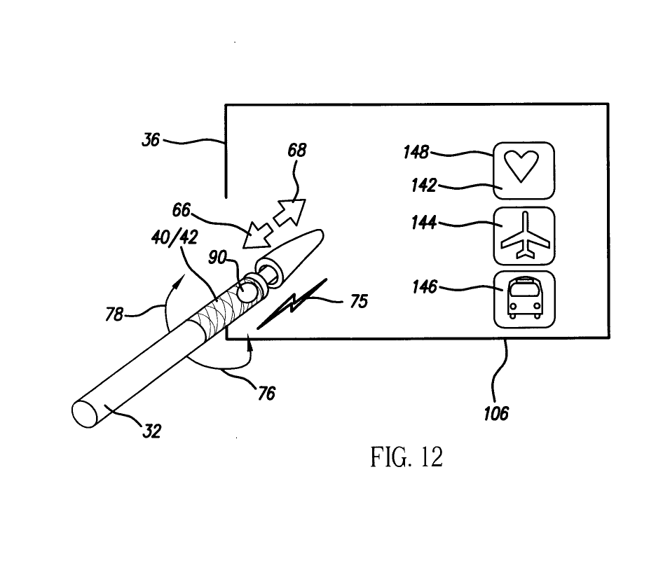

As is illustrated in FIG. 12, user input system 30 can be used to send output signals 75 that are interpreted by a controlled device 36. Here, sliding movement of input sleeve 40, along first direction 66, has caused a menu 140 to appear. Menu 140 has three icons, 142, 144 and 146, and rotation of input sleeve 40 in either of directions 76 and 78 causes a highlight cursor 148 to indicate which icon in menu 140 will be selected if first switch 90 is depressed. It will be appreciated that this arrangement is exemplary only, and that output signal 75 from user input system 30 can be interpreted differently by different devices.

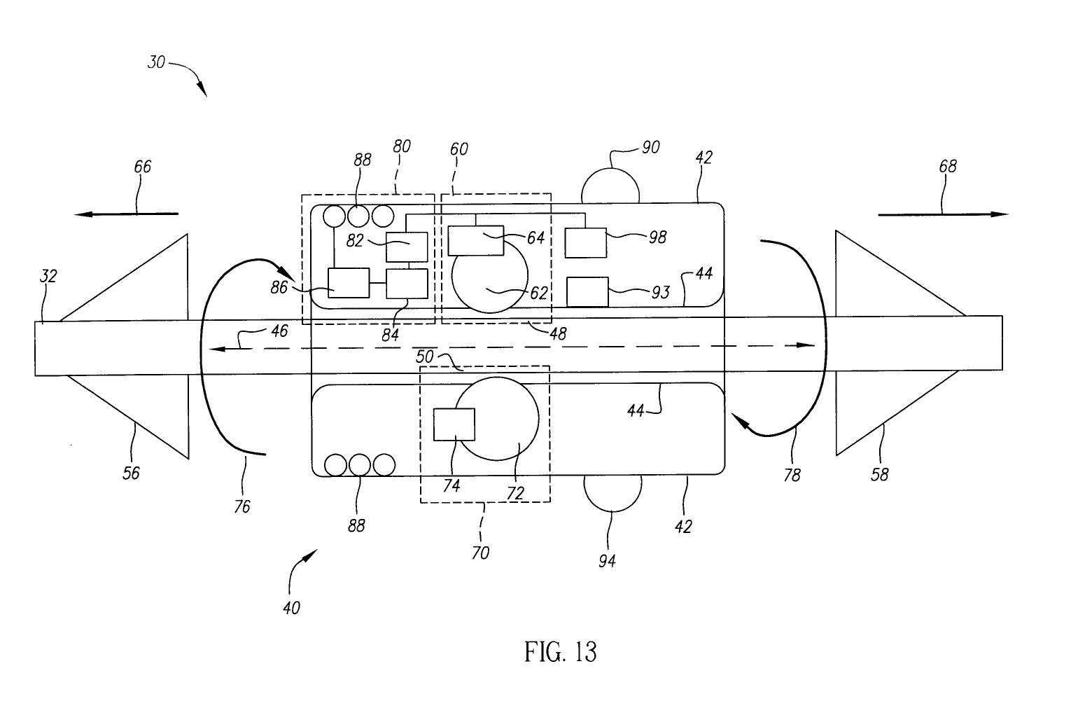

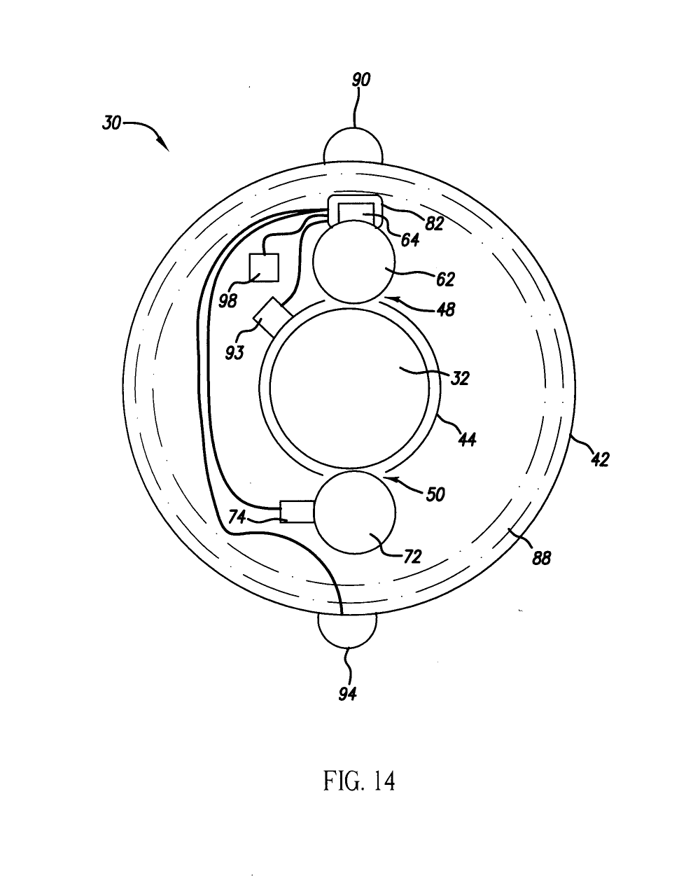

It will be appreciated that, in other embodiments, any or all of slide sensing system 60, rotation sensing system 70, and processing system 80 can be positioned, in whole or in part, on or in input sleeve 40. For example, in the embodiment of FIGS. 13 and 14, input sleeve 40 defines at least one area 48 allowing at least a portion of the slide sensing system 60 to be positioned confronting core 32. Slide sensing system 60 has slide sensor 62 that senses sliding movement of input sleeve 40 relative to core 32 and slide encoder 64 that causes a slide signal to be provided that indicates at least that input sleeve 40 has been moved along length 46 of core 32 and a direction of such movement along core 32 either in first direction 66 or second direction 68. In the embodiment illustrated, slide sensor 62 and slide encoder 64 are illustrated as separate components, with slide sensor 62 being illustrated as a follower wheel that is held against core 32 so that it rotates whenever input sleeve 40 slides along length 46. In this embodiment, slide encoder 64 provides well known electro-mechanical structures that detect rotation of slide sensor 62 and that generate or modulate an electrical signal in a manner that indicates an extent and a direction of movement of input sleeve 40 along length 46.

As is also shown in FIGS. 13 and 14, input sleeve 40 also defines an area 50 allowing rotation sensing system 70 to be positioned at least in part at interior surface 44 confronting core 32. Rotation sensing system 70 has a rotation sensor 72 that senses rotational movement of input sleeve 40 relative to core 32 and a rotation encoder 74 that causes a rotation signal to be generated that indicates at least an extent to which input sleeve 40 has been rotated relative to core 32 and, optionally, a direction of such rotation such as counter-clockwise direction 76 and clockwise direction 78. In the embodiment illustrated, rotation sensor 72 and rotation encoder 74 are illustrated as separate components, with the rotation sensor 72 being illustrated as a follower wheel that is held against core 32 and that rotates whenever input sleeve 40 rotates relative to core 32. In this embodiment, rotation encoder 74 provides electrical circuits that detect rotation of rotation sensor 72 and that generate or modulate an electrical signal in a manner that indicates an extent and a direction of rotation of input sleeve 40.

As is further shown in the embodiments of FIGS. 13 and 14, input sleeve 40 also accommodates processing system 80 which is illustrated as having an input 82 connected to slide encoder 64 to receive the slide signal (as illustrated in FIG. 13) and to rotation encoder 74 to receive the rotation signal (as illustrated in FIG. 14).

The invention has been described in detail with particular reference to certain preferred embodiments thereof, but it will be understood that variations and modifications can be effected within the spirit and scope of the invention.

### PARTS LIST

10 MP3 player
12 shuttle control switch
14 upper end
16 body
18 display
20 axis
30 user input system
32 core
32a first core portion
32b second core portion
32c third core portion
32d fourth core portion
36 controlled device
36a controlled device
36b controlled device
36c controlled device
36d controlled device
38 headphones
30 input sleeve
40a portion of input sleeve
42 exterior surface
43 gripping area
44 interior surface
44a portion of interior surface (in spec; not in drawings)
46 length
48 area
50 area
56 bumpers
58 bumpers
60 slide sensing system
60a-d slide sensor
62 slide sensor
64 slide encoder
66 first direction
68 second direction
70 rotation sensing system
70a-d rotation sensors
72 rotation sensor
74 rotation encoder
75 output signal
75a output signal
75b output signal
75c output signal
75d output signal
76 counter-clockwise direction
78 clockwise direction
80 processing system
82 input
84 processing circuit
86 communication circuit
88 antenna
90 first switch
91 determining system
93 sensor
93a-d sensors
94 second switch
98 battery
100 receiver
101 control signal
102 controller
104 display driver
106 controlled device
110 cursor
118 contact sensing circuit
119a-g segment
120 bumpers
122 bumpers
124 slots
126 slots
130 resilient members
132 resilient members
134 resilient members
136 resilient members
139 clip on feature
140 menu
142 icon
144 icon
146 icon
148 highlight cursor

1. A user input system comprising:
a core extending along a length;
an input sleeve having an exterior surface and an interior service shaped and sized to receive the core in a manner that permits slideable movement of the input sleeve along the length of the core and that permits rotation of the input sleeve relative to the core;
a slide sensing system having a slide sensor that senses sliding movement of the input sleeve relative to the core and that causes a slide signal to be generated that indicates at least that the input sleeve has been moved along the length of the core and a direction of such movement;
a rotation sensing system having a rotation sensor that senses rotational movement of the input sleeve relative to the core and that causes a rotation signal to be generated that indicates at least that the input sleeve has been rotated relative to the core; and
a processing system having an input to receive the slide signal and the rotation signal and a processing circuit adapted to determine an output signal based upon the slide signal and rotation signal.

2. The user input system of claim 1, wherein the slide sensing system is located at least in part in the core.

3. The user input system of claim 1, wherein the rotation sensing system is located at least in part in the core.

4. The user input system of claim 1, wherein the processing system is located at least in part in the core.

5. The user input system of claim 1, further comprising a first switch that can be selectively actuated by a combination of fingers used to grip the exterior surface of the input sleeve during slidable movement of the input sleeve or during rotation of the input sleeve, said first switch generating a first switch signal when actuated, wherein said processing system receives the first switch signal and is further adapted to determine the output signal based at least in part upon the first switch signal.

6. The user input system of claim 5, further comprising a second switch that can be selectively actuated by a combination of fingers used to grip the exterior surface of the input sleeve during slidable movement of the input sleeve or during rotation of the input sleeve, said second switch generating a second switch signal when actuated, wherein said processing system receives the second switch signal, and is further adapted to determine the output signal based at least in part upon the second switch signal.

7. The user input system of claim 6, wherein said processing system is adapted to determine the output signal differently in response to a received slide signal based upon whether a first switch signal is received during receipt of the slide signal or based upon whether a second switch signal is received during receipt of the slide signal.

8. The user input system of claim 7, wherein said processing system is adapted to determine the output signal differently in response to a received rotation signal based upon whether a first switch signal is received during receipt of the rotation signal or based upon whether a second switch signal is received during receipt of the rotation signal.

9. The user input system of claim 1, further comprising a first switch positioned on the exterior surface engageable by a thumb of a user gripping the input sleeve using a pincer grip and a second switch positioned so that it is engageable by the finger of the user when the user grips the exterior surface using a pincer grip.

10. The user input system of claim 6, wherein said first switch is arranged so that the first switch can be selectively actuated by a thumb of a user gripping the input sleeve with a pincer grip and wherein the second switch can be selectively actuated by a finger of a user gripping the input sleeve with said pincer grip, so that the application of a pincer grip can be determined when the first switch signal and second switch signal are received.

11. The user input system of claim 1, wherein said core comprises a flexible communication cable adapted to transmit digital or analog electrical, electromagnetic, optical or other signals to or from components of a digital or analog system and wherein said processing system comprises a communication system adapted to send a signal representing the determined output to the digital or analog system in a form that can be used by the digital or analog system during operation of the digital or analog system.

12. The user input system of claim 1, wherein the input sleeve is elastically resilient in a portion of the input sleeve such that the application of pressure to the exterior surface drives that portion of the interior surface into contact with the core, wherein a contact sensing circuit is provided that detects such contact and generates a first switch signal in response.

13. The user input control of claim 1, wherein said processing system has a processing circuit that comprises a controller for an electronic device, said controller being programmed or configured to determine said output signal such that said output influences the operation of the electronic device.

14. The user input system of claim 1, wherein said processing circuit comprises a communication circuit that determines an output in the form of a communication signal that is adapted for transmission to a controlled device that is remote from the user input control.

15. The user input system of claim 1, wherein said input sleeve is elastically resilient in a portion such that the application of pressure to exterior surface in that portion drives a corresponding portion of the interior surface into contact with core such that a contact sensing circuit can detect such contact and generate a first switch signal or second switch signal in response thereto.

16. A user input system comprising:
a core having at least two different portions;
an input sleeve having exterior surface and an interior service defining a receiving area for receiving the core, said interior surface further being shaped to permit slideable movement of the input sleeve along a length of the core and to permit rotation of the input sleeve relative to the core;
a slide sensing system having a slide sensor that senses sliding movement of the input sleeve relative to the core and that causes a slide signal to be generated that indicates at least that the input sleeve has been moved along the length of the core and a direction of such movement along said core;
a rotation sensing system having a rotation sensor positioned on the interior surface confronting the core that senses rotational movement of the input sleeve relative to the core and that causes a rotation signal to be generated that indicates at least that the input sleeve has been rotated relative to the core;
a portion determining system having a sensor that can sense a stimulus indicating which portion the core is located in, and that generates a portion signal; and
a processing system having an input to receive the slide signal, the rotation signal, and the portion signal, and a processing circuit adapted to determine an output based upon the slide signal, rotation signal, and portion signal;
wherein said input sleeve can be selectively positioned within either of the portions for movement along the portion and rotation about the portion, wherein at least one of said slide sensing system and said rotation sensing system has a sensor that is adapted to sense which portion of the core that the input sleeve is positioned in, and to generate the slide signal or the rotation signal in a manner that the processing system can use to determine which portion of the core input sleeve is located within, and to determine said output signal at least in part based upon the determined portion.

17. A user input system comprising:
a core means extending along a length;
an input sleeve having an exterior surface and an interior service shaped and sized to receive the core in a manner that permits slideable movement of the input sleeve along the length of the core and that permits rotation of the input sleeve relative to the core;
a slide sensing means for sensing sliding movement of the input sleeve relative to the core and for causing a slide signal to be generated that indicates at least that the input sleeve has been moved along the length of the core and a direction of such movement;
a rotation sensing means for sensing rotational movement of the input sleeve relative to the core and that causes a rotation signal to be generated that indicates at least that the input sleeve has been rotated relative to the core; and
a processing means for receiving the slide signal and the rotation signal and for determining an output signal based upon the slide signal and rotation signal.
